(19) United States
(12) Patent Application Publication
(10) Pub. No.: US 2005/0289611 A1
(43) Pub. Date: Dec. 29, 2005

(54) Subway-car broadcasting system

(75) Inventor: Hisao Taki, Tokyo (JP)

Correspondence Address: Finnegan, Henderson, Farabow,;Garrett & Dunner, L.L.P., 1300 I Street, N.W., Washington, DC, 20005-3315, US

(73) Assignee: NKB Inc.

(21) Appl. No.: 10/875,952

(22) Filed: Jun. 25, 2004

(51) Int. Cl. H04N 7/18

(52) U.S. Cl. 725/75; 725/78

(57) ABSTRACT

The object is to provide a subway-car broadcasting system in order to realize TV broadcasting in cars of subway trains. The system in which broadcasting contents are reproduced in cars of subway trains comprises: a center system which receives and/or captures broadcasting contents including ones on TV broadcasting and/or text broadcasting, and/or broadcasting contents which have been made, and transmits the broadcasting contents to station broadcasting systems provided in at least one or more stations; the station broadcasting systems which receive the broadcasting contents from the center system, and transmit the received broadcasting contents to the subway trains; and train broadcasting systems which receive the broadcasting contents transmitted from the received station broadcasting systems, and reproduce the received broadcasting contents in cars of the subway trains.

### BACKGROUND OF THE INVENTION

1. Field of the Invention

The present invention relates to a subway-car broadcasting system, by which contents on TV broadcasting and the like are reproduced for passengers aboard subway trains.

2. Description of the Prior Art

TV broadcasting, text broadcasting, and the like in railway cars have been an important method for passengers, who are kept in a closed space such as railway cars, to acquire information. Accordingly, in a part of narrow-gauge lines (for example, the Yamanote line), news, and the like recorded on a recording medium (videotape, and the like) have been reproduced, using image reproduction devices provided at a driver's compartment, a conductor compartment, and the like, and the news and the like have been shown to the passengers through display devices installed in the cars.

However, when the above-described method is used, it is difficult to provide up-to-the-minute information because only information recorded in the recording medium is reproduced. That is, in order to provide up-to-the-minute information, the above-described recording medium is required to be directly delivered from a station employee to a driver or a conductor frequently for its exchange. Accordingly, the frequent exchange increases the workload for the driver, the conductors, and the like to cause a problem from the viewpoint of smooth operation and the railway safety.

In order to solve the above-described problem, there has been a method in which radio waves for the TV broadcasting and the like are directly received for reproduction in the cars, but the radio waves can not be directly received in the case of subway trains because the subway trains are running in a tunnel. Moreover, the direct receiving can not be realized by problems that noises against the radio waves are generated through problems associated with the high voltage, and another one related with circumstances that iron powder is blown upwards from the tracks.

Moreover, though contents on text broadcasting have been reproduced by reproduction of recording media in cars on a part of narrow-gauge lines such as the Yamanote line as described above, only image reproduction has been performed, but sound one has not been done. The reason is that the sound reproduction in subway cars is nothing but noise for passengers who do not want to view the images, though the sound reproduction is useful for passengers who want to view the images. Accordingly, it is virtually impossible under the current circumstances to reproduces sounds in cars. However, this point is a problem when more extensive information is provided because sound reproduction is indispensable for the more extensive information.

### SUMMARY OF THE INVENTION

Considering the above problems, the present inventor has invented a subway-car broadcasting system, in which contents on TV broadcasting and the like can be reproduced in cars of subway trains, and, approximately the latest information (broadcasting contents) is broadcast.

According to the invention of Claim 1, the subway-car broadcasting system in which broadcasting contents are reproduced in cars of subway trains comprises: a center system which receives broadcasting contents including ones on TV broadcasting and/or text broadcasting, and transmits the broadcasting contents to station broadcasting systems provided in at least one or more stations; the station broadcasting systems which receive the broadcasting contents from the center system, and transmit the received broadcasting contents to the subway trains; and train broadcasting systems which receive the broadcasting contents transmitted from the station broadcasting systems, and reproduce the received broadcasting contents in cars of the subway trains.

According to the invention of Claim 2, the subway-car broadcasting system in which broadcasting contents are reproduced in cars of subway trains comprises: a center system which captures broadcasting contents made beforehand, and transmits the broadcasting contents to station broadcasting systems provided in at least one or more stations; the station broadcasting systems which receive the broadcasting contents from the center system, and transmits the received broadcasting contents to the subway trains; and train broadcasting systems which receive the broadcasting contents transmitted from the station broadcasting systems, and reproduce the received broadcasting contents in cars of the subway trains.

By these inventions, broadcasting contents such as the TV broadcasting can be reproduced approximately in real time even in cars of subway trains which run in tunnels.

According to the invention of Claim 3, the subway-car broadcasting system includes a center system which transmits data for broadcasting contents to station broadcasting systems which at least one or more stations comprise, and which transmit the data for broadcasting contents to be reproduced in cars of subway trains to the trains, wherein the center system comprises: a broadcasting storage unit which saves data for broadcasting contents; a broadcasting receive unit which receives broadcasting contents, including ones obtained through TV broadcasting and/or text broadcasting; a broadcasting capture unit which captures broadcasting contents which have been made beforehand; and a station transmit unit which extracts data for broadcasting contents to be transmitted to the station broadcasting system from the broadcasting storage unit, and transmits the broadcasting data to the station broadcasting system.

By the present invention, there can be a configuration in which contents on TV broadcasting, text broadcasting, and the like are received, or, advertisements which have been made, and the like are captured; data for the broadcasting contents are transmitted to stations; the data for broadcasting contents transmitted to stations are captured while subway trains stop at stations; and the broadcasting contents are reproduced in cars of subway trains while the subway trains are running between stations.

According to the invention of Claim 4, in the subway-car broadcasting system, the center system further comprises an encoding unit which encodes the broadcasting contents, which have been received through the broadcasting receive unit, in a well-known data format, and saves the encoded broadcasting contents in the broadcasting storage unit.

According to the invention of Claim 5, in the subway-car broadcasting system, the center system further comprises an encoding unit which encodes the broadcasting contents, which have been captured through the broadcasting capture unit, in a well-known data format, and saves the encoded broadcasting contents in the broadcasting storage unit.

By these inventions, broadcasting contents can be reproduced by encoding the broadcasting contents in a well-known data format, and by decoding the broadcasting contents in subway trains, even when the broadcasting contents are not digital data.

According to the invention of Claim 6, the center system comprises a station broadcasting management unit which decides data for broadcasting contents to be transmitted to the station broadcasting system in the subway-car broadcasting system.

By this invention, broadcasting contents to be transmitted to stations can be arbitrarily managed.

According to the invention of Claim 7, in the subway-car broadcasting system, the center system comprises a schedule storage unit saving a service schedule of the subway trains, and the station broadcasting management unit decides the data for broadcasting contents, based on the service schedule of the subway trains saved in the schedule storage unit.

By this invention, broadcasting contents to be transmitted to stations can be decided, based on service schedules (for example, diagrams, and the like) of subway trains.

According to the invention of Claim 8, the subway-car broadcasting system includes a station broadcasting system which receives data for broadcasting contents from a center system, which has received the broadcasting contents to be reproduced in cars of subway trains, through a network, and transmits the data for broadcasting contents to the subway trains, wherein the station broadcasting system comprises: a contents storage unit which saves data for broadcasting contents to be transmitted to the trains; a station receive unit which receives data for broadcasting contents to be reproduced in the cars of subway train from the center system, and saves the data in the contents storage unit, and a train transmit unit which transmits data for broadcasting contents saved in the contents storage unit to the trains after the train arrives at a platform of a station.

According to the invention of Claim 9, the subway-car broadcasting system includes a station broadcasting system which receives data for broadcasting contents from a center system, which has captured the broadcasting contents, which have been made beforehand, to be reproduced in cars of subway trains, through a network, and transmits the data for broadcasting contents to the subway trains, wherein the station broadcasting system comprises: a contents storage unit which saves data for broadcasting contents to be transmitted to the trains; a station receive unit which receives data for broadcasting contents to be reproduced in the cars of subway trains from the center system, and saves the data in the contents storage unit, and a train transmit unit which transmits data for broadcasting contents saved in the contents storage unit to the trains after the train arrives at a platform of a station.

By these inventions, there can be a configuration in which data for broadcasting contents which have been received and/or captured in the center system is transmitted to subway trains while the subway trains stop at stations; and the broadcasting contents are reproduced in cars of the subway trains while the trains are running between stations.

According to the invention of Claim 10, the subway-car broadcasting system includes a train broadcasting system which receives the data for broadcasting contents from a station broadcasting system which receives the data for broadcasting contents through a network from a center system which has received the broadcasting contents to be reproduced in cars of subway trains, wherein the train broadcasting system comprises: a car information storage unit which saves data for broadcasting contents to be reproduced in the cars; a train receive unit which receives data for the broadcasting contents from the station broadcasting system, and saves the data in the car information storage unit; an image reproducing unit which reproduces images of the received broadcasting contents through at least one or more display devices provided in the cars; and a sound reproducing unit which reproduces sounds of the received broadcasting contents through wireless communication at a predetermined radio frequency.

According to the invention of Claim 11, the subway-car broadcasting system includes a train broadcasting system which receives data for broadcasting contents through a network from a station broadcasting system, which receives data for the broadcasting contents from a center system which has captured the broadcasting contents, which have been made beforehand, to be reproduced in cars of subway trains, through a network, wherein the train broadcasting system comprises: a car information storage unit which saves data for broadcasting contents to be reproduced in the cars; a train receive unit which receives the data for broadcasting contents from the station broadcasting system, and saves the data in the car information storage unit; an image reproducing unit which reproduces images of the received broadcasting contents through at least one or more display devices provided in the cars; and a sound reproducing unit which reproduces sounds of the received broadcasting contents through wireless communication at a predetermined radio frequency.

By these inventions, there can be a configuration in which data for broadcasting contents is received from the station broadcasting system which has received the data for broadcasting contents received and/or captured by the center system, and is reproduced while trains are running between stations. Thereby, broadcasting contents can be reproduced even in cars of subway trains, and, furthermore, not only simple reproduction but also approximately real-time reproduction of the broadcasting contents can be realized. Additionally, different broadcasting contents may be reproduced for each subway car and/or on each display device. Thereby, broadcasting contents dedicated for special targets can be reproduced, for example, broadcasting contents appropriate for women can be reproduced in a women-only car. Moreover, when data for broadcasting contents is received from the station broadcasting system, it is preferable to use electromagnetic wave communication (for example, such as infrared communication), and the like (same applies hereinafter).

According to the invention of Claim 12, the subway-car broadcasting system includes a train broadcasting system which receives data for broadcasting contents through a network from a station broadcasting system, which receives the data for broadcasting contents from a center system which has received and captured the broadcasting contents to be reproduced in cars of subway trains, through a network, wherein the train broadcasting system comprises: a car information storage unit which saves data for broadcasting contents to be reproduced in the cars; a train receive unit which receives the data for broadcasting contents from the station broadcasting system, and saves the data in the car information storage unit; and an individual transmit unit which transmits images and/or sounds of the received broadcasting contents to terminals which passengers in the cars carry.

According to the invention of Claim 13, the subway-car broadcasting system includes a train broadcasting system which receives data for broadcasting contents through a network from a station broadcasting system, which receives the data for broadcasting contents from a center system which has captured the broadcasting contents, which have been made beforehand, to be reproduced in cars of subway trains, through a network, wherein the train broadcasting system comprises: a car information storage unit which saves data for broadcasting contents to be reproduced in the cars; a train receive unit which receives the data for broadcasting contents from the station broadcasting system, and saves the data in the car information storage unit; and an individual transmit unit which transmits images and/or sounds of the received broadcasting contents to terminals which passengers in the cars carry.

By these inventions, there can be a configuration in which data for broadcasting contents are received from the station broadcasting system which has received the broadcasting contents received and/or captured in the center system, and the broadcasting contents are reproduced on terminals which passengers carry, while trains are running between stations. Thereby, broadcasting contents can be reproduced even in cars of subway trains, and, furthermore, not only simple reproduction but also approximately real-time reproduction of the broadcasting contents can be realized.

According to the invention of Claim 14, in the subway-car broadcasting system, the train broadcasting system comprises: a decoding unit which decodes data for broadcasting contents encoded in an encoding unit in the center system when the broadcasting contents are reproduced according to a predetermined broadcasting schedule.

By this invention, when broadcasting contents are not digital data, encoded data for the broadcasting contents which have been transmitted from the center system can be decoded, and the broadcasting contents can be reproduced in a car of subway trains.

According to the invention of Claim 15, the train receive unit receives the data for broadcasting contents from the station broadcasting system, using a wireless communication technology, in the subway-car broadcasting system.

According to this invention, data for broadcasting contents can be received by wireless communication such as Bluetooth technology, and infrared communication, when the data are received from a station broadcasting system in a subway train.

According to the invention of Claim 16, the wireless communication uses radios in the subway-car broadcasting system.

Generally, reproduction of sounds for broadcasting contents in trains using a speaker and the like is not preferable, because the reproduction using a speaker and the like is nothing but noise for passengers who neither want to view the images nor wish to listen to the sounds, though the reproduction using the speaker and the like is useful for passengers who want to view the images and to listen to the sounds. Accordingly, reproduction of sounds in a car has not been realized so far. On the other hand, sounds are indispensable to provide passengers with more attractive information.

Then, the present inventor has proposed a system in which sounds are reproduced through wireless communication using radios and the like. According to the system, passengers who want to listen to the sounds for related images can listen to the sounds for the images by sound reproduction through wireless communication using radios and the like, and there are generated no disadvantages for passengers who do not want to listen to the sounds. That is, a system respecting advantages for both kinds of passengers can be realized.

Accordingly, the effect of information provision can be improved by combination of images and sounds through the present invention, though reproduction of only images has been less effective for providing information on advertisements, and the like.

### BRIEF DESCRIPTION OF THE DRAWINGS

FIG. 1 is a system block diagram showing one example of a system configuration according to the present invention;

FIG. 2 is a flow chart showing one example of a process flow according to the present invention;

FIG. 3 is a flow chart showing one example of a process flow according to the present invention;

FIG. 4 is a conceptual view for a case in which data is transmitted to a car from a platform and the like; and

FIG. 5 is a conceptual view for a case in which passengers view images, and listen to sounds.

### DESCRIPTION OF THE PREFERRED EMBODIMENT

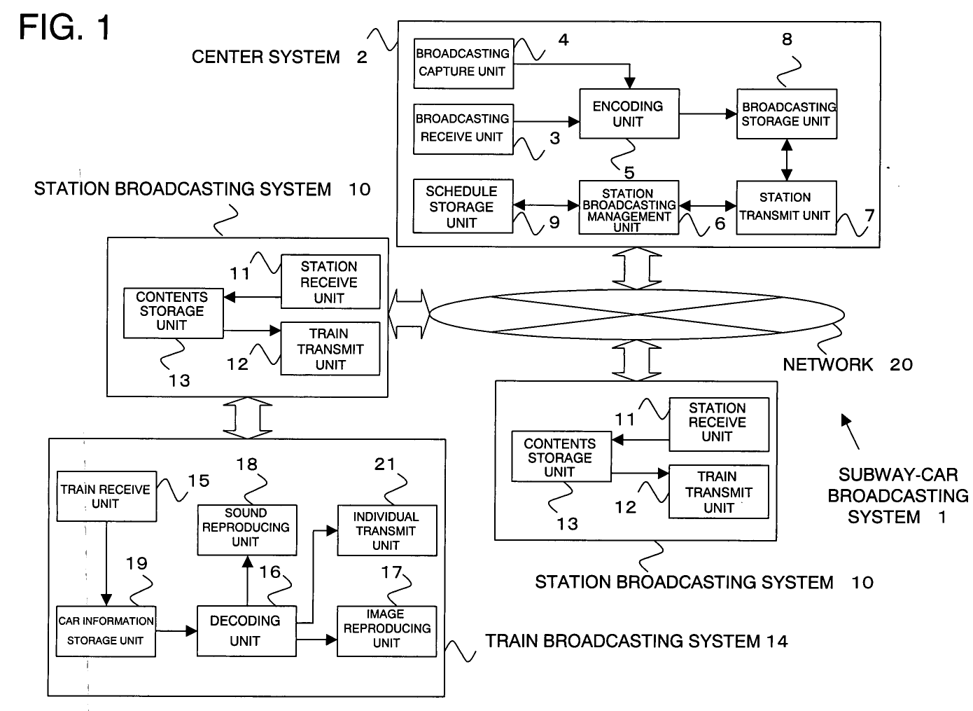

One example of a system configuration according to an embodiment of the present invention is shown in FIG. 1 as a system block diagram. A subway-car broadcasting system 1 comprises: a center system 2 which receives broadcasting contents to be reproduced in a subway car, and transmits them to stations; station broadcasting systems 10 which receive the broadcasting contents from the center system 2, and transmit them to trains; and train broadcasting systems 14 which receive the broadcasting contents from a station, and reproduce the broadcasting contents. Here, a case in which the broadcasting contents themselves are analog data will be explained in this embodiment. Accordingly, encoding and decoding are not required when the broadcasting contents are not analog data.

Data can be exchanged between the center system 2 and the station broadcasting systems 10 through a network 20. Here, the network 20 may be any one of an open network such as the Internet, a closed network such as a local area network (LAN), or one of combinations of the two networks, such as an intranet. Moreover, a wired network, a wireless one, a public telephone one, a dedicated line, or the like may be also applied to the network 20.

Direct transmitting and receiving of data can be realized between the station broadcasting systems 10 and the train broadcasting systems 14, using a well-known wireless communication technology such as Bluetooth technology, and infrared communication.

The center system 2 comprises: a broadcasting receive unit 3; a broadcasting capture unit 4; an encoding unit 5; a station broadcasting management unit 6; a station transmit unit 7; a broadcasting storage unit 8; and a schedule storage unit 9.

The broadcasting receive unit 3 is a unit which receives broadcasting contents (for example, items of news and sports, economic information on stock prices, or the like, and the like) on TV broadcasting, text broadcasting, or the like.

The broadcasting capture unit 4 is a unit which captures broadcasting contents (for example, advertisements, information on a subway, and the like), which the unit 4 itself, an advertising agency, or the like has made.

The encoding unit 5 is a unit which encodes the broadcasting contents, which have been received or captured through the broadcasting receive unit 3 and/or the broadcasting capture unit 4, in a well-known data format (for example, an MPEG format), and which saves the contents in the broadcasting storage unit 8. Moreover, when the broadcasting contents are not analog data (when the contents are digital data), the encoding unit 5 is not required because the broadcasting contents can be reproduced without being processed.

The station broadcasting management unit 6 is a unit which decides, based on the service schedule of trains saved in the service schedule unit 9 (to be described later), broadcasting contents to be reproduced in the subway train between stations, and data for the broadcasting contents to be transmitted to stations. For example, information X on sports, and economic information Y are decided to be reproduced for between a station A and a station B, and for between the station B and a station C, respectively. Accordingly, it is decided that the data X and the data Y are transmitted to the station A and to the station B, respectively.

The station transmit unit 7 is a unit which extracts data to be transmitted to the stations, which has been decided in the station broadcasting management unit 6, from the broadcasting storage unit 8, and transmits the data to the station broadcasting systems 10 provided at stations through the network 20.

The broadcasting storage unit 8 is a storage unit which saves the data for the broadcasting contents, which have been encoded in the encoding unit 5.

The schedule storage unit 9 is a storage unit which saves the service schedules of trains.

The station broadcasting systems 10 are provided at stations, and are a system in which data to be reproduced after a train arrives at a platform is transmitted to trains. The systems 10 comprise: a station receive unit 11; a train transmit unit 12; and a contents storage unit 13.

The station receive unit 11 is a unit which receives the data for broadcasting contents from the center system 2 through the network 20, and saves the data in the contents storage unit 13 (will be described later).

The train transmit unit 12 is a unit which is provided in a platform of a station and the like, and which transmits the data for the broadcasting contents saved in the contents storage unit 13 to the train broadcasting system 14, using a well-known wireless communication technology such as Bluetooth technology, and infrared communication, after a train arrives at the platform and before the train leaves the platform.

The contents storage unit 13 is a storage unit which saves the data for broadcasting contents to be transmitted to trains.

The train broadcasting system 14 comprises; a train receive unit 15; a decoding unit 16; an image reproducing unit 17; a sound reproducing unit 18; an individual transmit unit 21; and a car information storage unit 19.

The train receive unit 15 is a unit which receives the data for the broadcasting contents from the station broadcasting system 10, using a well-known wireless communication technology such as Bluetooth technology, and infrared communication, and saves the data in the car information storage unit 19 (will be described later).

The decoding unit 16 is a unit which decodes the data encoded in the encoding unit 5 of the center system 2 when the broadcasting contents are reproduced according to a predetermined broadcasting schedule. Moreover, when the broadcasting contents have not been encoded in the encoding unit 5, the decoding unit 16 may be eliminated because the broadcasting contents can be reproduced without being processed.

The image reproducing unit 17 is a unit which reproduces images of the broadcasting contents decoded in the decoding unit 16 through a liquid crystal display device, a plasma display device, and the like, which are installed in cars. Moreover, when decoding of the broadcasting contents is not required, the images of the received contents are reproduced without being processed.

The sound reproducing unit 18 is a unit which reproduces the sounds of the broadcasting contents decoded by the decoding unit 16 through wireless communication (using radios and the like) at a predetermined radio frequency. Accordingly, passengers in cars can listen to the sounds with a portable radio, and the like by adjusting the frequency of the radio to the above-described frequency. Furthermore, when decoding of the broadcasting contents is not required, the sounds of the received contents are reproduced without being processed.

The car information storage unit 19 is a storage unit which saves the data of the broadcasting contents to be reproduced in the car.

The individual transmit unit 21 is a unit which, using a well-known wireless communication technology transmits the images and/or the sounds of the broadcasting contents to a terminal (not shown) (for example, a cellular telephone, a PHS, a PDA, and a notebook-sized personal computer, and the like), which the passengers in cars carry, and reproduces the images and/or the sounds. The individual transmit unit 21 may be included in the sound reproducing unit 18 and/or in the image reproducing unit 17, or, it is also obvious that the unit 21 may be independently provided. Moreover, when decoding of the broadcasting contents is not required, the data of the received broadcasting contents are reproduced without being processed.

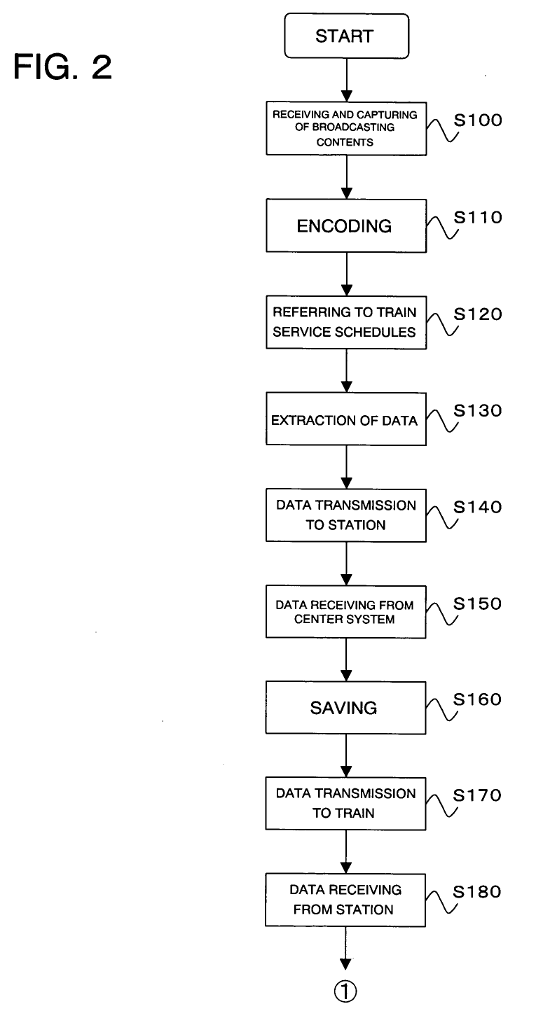

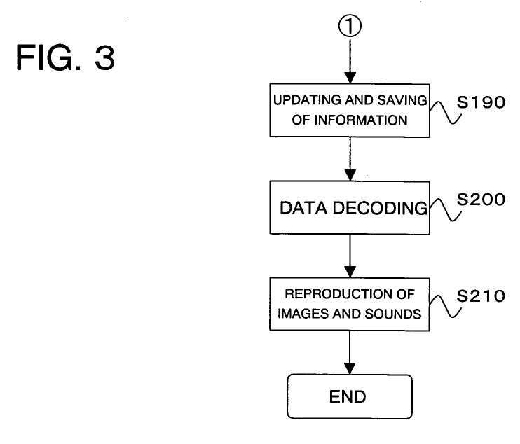

One example of a process flow according to the present invention will be explained in detail, using a flow chart shown in FIGS. 2 and 3, and a system block diagram shown in FIG. 1.

When some broadcasting contents, for example, on TV broadcasting, text broadcasting, or the like are reproduced in a car of a subway train, TV broadcasting, or the like is received with the broadcasting receive unit 3 in the center system 2; and when broadcasting contents (advertisements, information on a subway, and the like), which the broadcasting capture unit 4 itself, or an advertising agency, or the like has made, are reproduced, the broadcasting contents are captured in the broadcasting capture unit 4 (step S100).

The broadcasting contents, which have been received or captured through the broadcasting receive unit 3 and/or the broadcasting capture unit 4, are encoded in a well-known data format (for example, an MPEG format) in the encoding unit 5 in order to convert the broadcasting contents from analogue form into digital one, and the broadcasting contents are saved in a broadcasting data base (step S110).

Referring to the service schedules of trains, which have been saved in the schedule storage unit 9, the station broadcasting management unit 6 decides broadcasting contents to be reproduced in cars of subway trains, based on the current positions and the train numbers of subway trains, the current time, and the like (step S120). For example, information X on sports, and economic information Y are decided to be reproduced for between a station A and a station B, and for between the station B and a station C, respectively. Accordingly, it is decided that the data X and the data Y are transmitted to the station A and to the station B, respectively. In the above-described case, the broadcasting contents to be reproduced may be decided, considering statistical data on passengers, such as required time between stations, and a configuration (for example, more male ratio, more female ratio, more young-person ratio, or more elderly-person ration) of passengers on the train.

The station transmit unit 7 extracts pieces of the data for the broadcasting contents, which are to be transmitted to the stations, from the broadcasting storage unit 8, based on the broadcasting contents decided in the station broadcasting management unit 6, and transmits the pieces of data to the station broadcasting systems 10 through the network 20 (step S140).

The pieces of data for the broadcasting contents are received from the station transmit unit 7 of the center system 2 in the station receive units 11 of the station broadcasting systems 10 through the network 20 (step S150). The station receive units 11 save the data received at a step S150 in the contents storage units 13 (step S160).

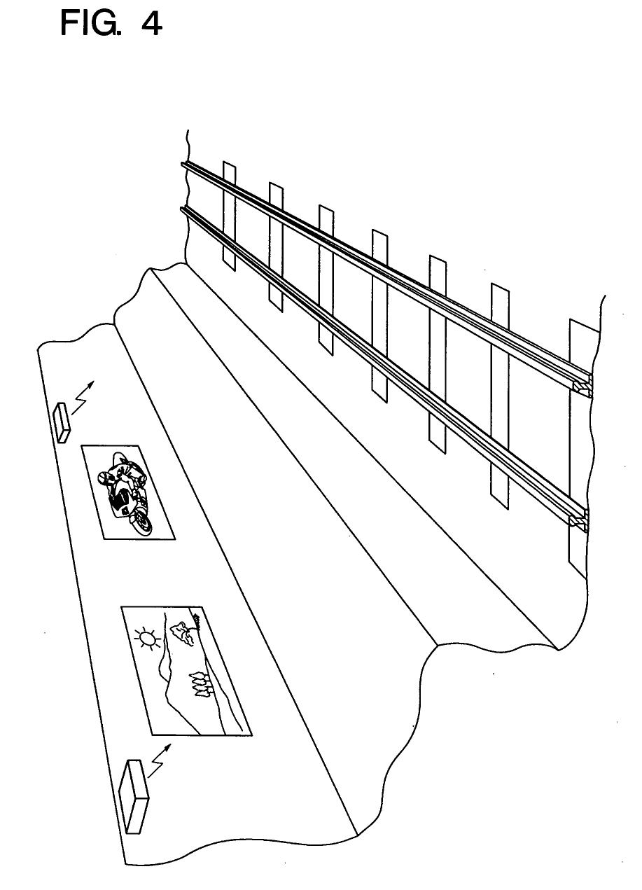

After a train arrives at a platform, the train transmit unit 12 which is provided in the platform or the like transmits the data for the broadcasting contents, which have been received at the step S150 and have been saved in the contents storage unit 13, to the train broadcasting system 14, using a well-known wireless communication technology (step S170). FIG. 4 shows a conceptual view for a case in which the train transmit unit 12 provided in the platform and the like transmits the data to the car.

The train receive unit 15 in the train broadcasting system 14, which is provided in a car, receives the data for the broadcasting contents which have been transmitted to the car at the step S170 (step S180). The train receive unit 15 saves the received data in the car information storage unit 19, and the broadcasting contents to be reproduced in the car are updated (step S190).

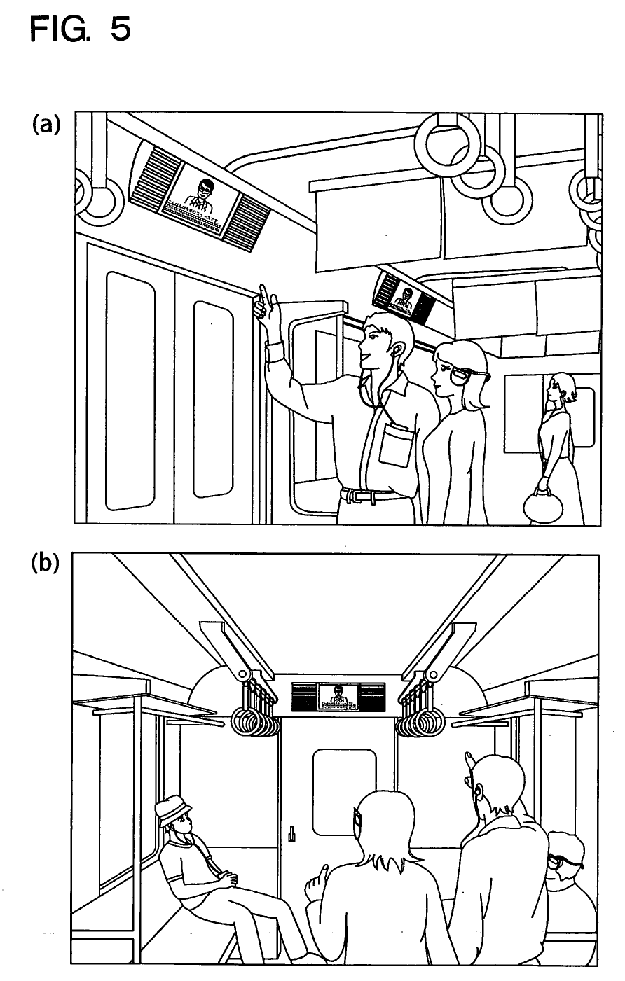

The data for the broadcasting contents saved in the car information storage unit 19 is decoded (that is, the form of the data for the broadcasting contents, which has been encoded at the step S110, is changed into the original one) by the decoding unit 16 according to broadcasting timing (time for broadcasting, broadcasting order, and the like) of the broadcasting contents, and image data is reproduced and shown to passengers by the image reproducing unit 17 through liquid crystal display devices, plasma display devices, and the like, which have been installed in the car beforehand. Moreover, the sound data is reproduced by the sound reproducing unit 18, using wireless communication at a predetermined frequency (step S210). FIGS. 5(a) and 5(b) show a conceptual view for a case in which passengers view images, and listen to sounds. FIG. 5(a) is a view for a case in which display devices are provided at the upper portions of doors in the car, and FIG. 5(b) is a view for a case in which display devices are provided at the upper portions of doors in the coupling sections of the car.

Accordingly, passengers who want only to view the images view the images reproduced on the liquid crystal display devices, the plasma display devices, and the like. On the other hand, passengers who want to view the images and, at the same time, to listen to the sounds can view the images on the liquid crystal display devices, the plasma display devices, and the like, and, at the same time, listen to the sounds, using the portable radios after adjusting the respective frequencies of their portable radios, which the passengers themselves carry, to a predetermined frequency.

Moreover, a plurality of broadcasting contents to be reproduced in a car can be provided. For example, when two sorts of broadcasting contents are reproduced at the same time, two pieces of data corresponding to the two sorts of broadcasting contents are received from the station broadcasting system 10 by the train broadcasting system 14, and the two pieces of data can be reproduced in cars. At this time, there may be applied a configuration in which the number of liquid crystal display devices, or plasma display devices, and that of frequencies for transmitting the sounds are set to be equal to the number of broadcasting contents to be reproduced, and each piece of image data and each piece of sound data are reproduced on the corresponding display devices. There may be also applied another configuration in which the number of display devices is one, but the number of frequencies for transmitting the sounds are set to be equal to the number of contents to be reproduced to allow passengers to view one piece of image data and to listen to a plurality of broadcasting contents at the same time. Furthermore, only image data, or only sound data may be separately reproduced in a car.

Moreover, the individual transmit unit 21 may transmit the data for the broadcasting contents, which have been decoded at the step S200, to a terminal (for example, a portable telephone, PHS, PDA, and a notebook-sized personal computer, and the like) (not shown) which a passenger carries to allow each passenger to view the data in an individual manner. A well-known wireless communication technology may be applied to a method for transmission in the above case, for example, Bluetooth technology, infrared communication (IrDA), or the like may be adopted. Thereby, each passenger can independently view desired broadcasting contents.

Furthermore, there may be also applied a configuration in which broadcasting contents, which have been received/captured by the center system may be simply transmitted to stations at any time without any management of broadcasting contents to be transmitted to stations, and the transmitted broadcasting contents are simply reproduced in subway trains.

By executing the above-described steps or processes, drivers are required only to run subway trains according to service schedules; drivers, conductors, or the like are not required to execute conventional direct delivering of recording medium for broadcasting contents; and reproduction of necessary broadcasting contents in a subway car can be realized only by receiving of the broadcasting contents from stations to reduce the workload of the drivers and the conductors.

Moreover, broadcasting contents can be reproduced approximately in real time even in cars of subway trains which run in tunnels and in which broadcasting contents on TV broadcasting, and the like can not be received directly from the air.

The functions of units, and storage units in the present invention are discriminated only from a logical view point, and the units and the storage units may be included in the same region from a physical or substantial view point. Moreover, description as “storage unit” means that a data base, a data file, and other storage forms are included.

Here, it is obvious that storage medium in which storage programs for realizing functions of the present embodiment are recorded is supplied to a system, and computers in the system read and execute the programs saved in the storage medium to execute the present invention.

In this case, the programs themselves, read from the storage medium, are meant to execute functions of the above-described embodiment, and it is obvious that the storage medium saving the programs forms the present invention.

For example, floppy disks, hard disks, optical disks, magneto optical disks, magnetic tapes, non-volatile memory cards, or the like can be used as storage medium in order to supply the programs.

Moreover, it is obvious that there may be included not only a case in which functions of the above-described embodiment may be realized by executing programs which computers read, but also another case in which operating systems, and the like operating on the computers execute a part of, or all of the actual processing, based on instructions of the programs, and the functions of the above-described embodiment are realized by the processing.

Furthermore, it is obvious that there may be included a case in which, after programs read from storage medium are written in non-volatile or volatile storage units provided in function expansion boards inserted in the computers, or in function expansion units connected to the computers, arithmetic processing units and the like provided in the function expansion boards or the function expansion units execute a part of or all of actual processing, based on the instructions of the programs, and the functions of the above-described embodiment are executed by the processing.

According to the present invention, reproduction of necessary broadcasting contents in a subway car can be realized by receiving necessary broadcasting contents from stations without the workload of drivers and conductors, which is caused by conventional exchanging of broadcasting contents through direct delivering between the drivers and the conductors, though drivers are required only to run subway trains according to service schedules in a similar manner to a conventional one. Moreover, those who manage subway trains can make broadcasting contents in a voluntary manner to broadcast the broadcasting contents in subway trains, that is, a broadcasting function can be also realized.

Moreover, broadcasting contents can be reproduced approximately in real time even in cars of subway trains which run in tunnels and in which broadcasting contents on TV broadcasting, and the like can not be received directly from the air.

In addition, not only reproduction of images in the cars, but also simultaneous reproduction of both images and sounds therein can be realized. In such a case, the image and sound reproduction in cars has been not preferable so far, because the image and sound reproduction in cars is useful for passengers who want to view the images and wish to listen to the sounds, but is nothing but noise for passengers who neither want to view the images, nor wish to listen to the sounds. Then, according the present invention, there can be realized a system in which passengers who want to listen to the sounds can listen to the sounds by sound reproduction through wireless communication using radios and the like, and there are generated no disadvantages for passengers who do not want to listen to the sounds, respecting advantages for both kinds of passengers. Accordingly, not only reproduction of images, but also more interactive exchange of information can be provided by the present invention.

1. A subway-car broadcasting system in which broadcasting contents are reproduced in cars of subway trains, comprising:
a center system which receives broadcasting contents including ones on TV broadcasting and/or text broadcasting, and transmits the broadcasting contents to station broadcasting systems provided in at least one or more stations;
the station broadcasting systems which receive the broadcasting contents from the center system, and transmit the received broadcasting contents to the subway trains; and
train broadcasting systems which receive the broadcasting contents transmitted from the station broadcasting systems, and reproduce the received broadcasting contents in cars of the subway trains.

2. A subway-car broadcasting system in which broadcasting contents are reproduced in cars of subway trains, comprising:
a center system which captures broadcasting contents made beforehand, and transmits the broadcasting contents to station broadcasting systems provided in at least one or more stations;
the station broadcasting systems which receive the broadcasting contents from the center system, and transmits the received broadcasting contents to the subway trains; and
train broadcasting systems which receive the broadcasting contents transmitted from the station broadcasting systems, and reproduce the received broadcasting contents in cars of the subway trains.

3. A subway-car broadcasting system including a center system which transmits data for broadcasting contents to station broadcasting systems which at least one or more stations comprise, and which transmit the data for broadcasting contents to be reproduced in cars of subway trains to the trains, wherein
the center system comprises:
a broadcasting storage unit which saves data for broadcasting contents;
a broadcasting receive unit which receives broadcasting contents including ones on TV broadcasting and/or text broadcasting;
a broadcasting capture unit which captures broadcasting contents which have been made beforehand; and
a station transmit unit which extracts data for broadcasting contents to be transmitted to the station broadcasting system from the broadcasting storage unit, and transmits the broadcasting data to the station broadcasting system.

4. The subway-car broadcasting system according to claim 3, wherein
the center system further comprises an encoding unit which encodes the broadcasting contents, which have been received through the broadcasting receive unit, in a well-known data format, and saves the encoded broadcasting contents in the broadcasting storage unit.

5. The subway-car broadcasting system according to claim 3, wherein
the center system further comprises an encoding unit which encodes the broadcasting contents, which have been captured through the broadcasting capture unit, in a well-known data format, and saves the encoded broadcasting contents in the broadcasting storage unit.

6. The subway-car broadcasting system according to any one of claims 3 through 5, wherein
the center system comprises a station broadcasting management unit which decides data for broadcasting contents to be transmitted to the station broadcasting system.

7. The subway-car broadcasting system according to any one of claims 3 through 6, wherein
the center system comprises a schedule storage unit saving a service schedule of the subway trains, and
the station broadcasting management unit decides the data for broadcasting contents, based on the service schedule of the subway trains saved in the schedule storage unit.

8. A subway-car broadcasting system including a station broadcasting system which receives data for broadcasting contents from a center system, which has received the broadcasting contents to be reproduced in cars of subway trains, through a network, and transmits the data for broadcasting contents to the subway trains, wherein
the station broadcasting system comprises:
a contents storage unit which saves data for broadcasting contents to be transmitted to the trains;
a station receive unit which receives data for broadcasting contents to be reproduced in the cars of subway train from the center system, and saves the data in the contents storage unit, and
a train transmit unit which transmits data for broadcasting contents saved in the contents storage unit to the trains after the train arrives at a platform of a station.

9. A subway-car broadcasting system including a station broadcasting system which receives data for broadcasting contents from a center system, which has captured the broadcasting contents, which have been made beforehand, to be reproduced in cars of subway trains, through a network, and transmits the data for broadcasting contents to the subway trains, wherein
the station broadcasting system comprises:
a contents storage unit which saves data for broadcasting contents to be transmitted to the trains;
a station receive unit which receives data for broadcasting contents to be reproduced in the cars of subway trains from the center system, and saves the data in the contents storage unit, and
a train transmit unit which transmits data for broadcasting contents saved in the contents storage unit to the trains after the train arrives at a platform of a station.

10. A subway-car broadcasting system including a train broadcasting system which receives the data for broadcasting contents from a station broadcasting system which receives the data for broadcasting contents through a network from a center system which has received the broadcasting contents to be reproduced in cars of subway trains, wherein
the train broadcasting system comprises:
a car information storage unit which saves data for broadcasting contents to be reproduced in the cars;
a train receive unit which receives data for the broadcasting contents from the station broadcasting system, and saves the data in the car information storage unit;
an image reproducing unit which reproduces images of the received broadcasting contents through at least one or more display devices provided in the cars; and
a sound reproducing unit which reproduces sounds of the received broadcasting contents through wireless communication at a predetermined radio frequency.

11. A subway-car broadcasting system including a train broadcasting system which receives data for broadcasting contents through a network from a station broadcasting system, which receives data for the broadcasting contents from a center system which has captured the broadcasting contents, which have been made beforehand, to be reproduced in cars of subway trains, through a network, wherein
the train broadcasting system comprises:
a car information storage unit which saves data for broadcasting contents to be reproduced in the cars;
a train receive unit which receives the data for broadcasting contents from the station broadcasting system, and saves the data in the car information storage unit;
an image reproducing unit which reproduces images of the received broadcasting contents through at least one or more display devices provided in the cars; and
a sound reproducing unit which reproduces sounds of the received broadcasting contents through wireless communication at a predetermined radio frequency.

12. A subway-car broadcasting system including a train broadcasting system which receives data for broadcasting contents through a network from a station broadcasting system, which receives the data for broadcasting contents from a center system which has received and captured the broadcasting contents to be reproduced in cars of subway trains, through a network, wherein
the train broadcasting system comprises:
a car information storage unit which saves data for broadcasting contents to be reproduced in the cars;
a train receive unit which receives the data for broadcasting contents from the station broadcasting system, and saves the data in the car information storage unit; and
an individual transmit unit which transmits images and/or sounds of the received broadcasting contents to terminals which passengers in the cars carry.

13. A subway-car broadcasting system including a train broadcasting system which receives data for broadcasting contents through a network from a station broadcasting system, which receives the data for broadcasting contents from a center system which has captured the broadcasting contents, which have been made beforehand, to be reproduced in cars of subway trains, through a network, wherein
the train broadcasting system comprises:
a car information storage unit which saves data for broadcasting contents to be reproduced in the cars;
a train receive unit which receives the data for broadcasting contents from the station broadcasting system, and saves the data in the car information storage unit; and
an individual transmit unit which transmits images and/or sounds of the received broadcasting contents to terminals which passengers in the cars carry.

14. The subway-car broadcasting system according to any one of claims 1 through 13, wherein
the train broadcasting system comprises: a decoding unit which decodes data for broadcasting contents encoded in an encoding unit in the center system when the broadcasting contents are reproduced according to a predetermined broadcasting schedule.

15. The subway-car broadcasting system according to any one of claims 10 through 13, wherein
the train receive unit receives the data for broadcasting contents from the station broadcasting system, using a wireless communication technology.

16. The subway-car broadcasting system according to claim 10 or 11, wherein
the wireless communication uses radios.
